(19) United States
(12) Patent Application Publication
(10) Pub. No.: US 2024/0185582 A1
(43) Pub. Date: Jun. 6, 2024

(54) ANNOTATION-EFFICIENT IMAGE ANOMALY DETECTION

(71) Applicant: ECOLE POLYTECHNIQUE FEDERALE DE LAUSANNE (EPFL), Lausanne (CH)

(72) Inventors: Behzad BOZORGTABAR, Lausanne (CH); Jean-Philippe THIRAN, Granges (CH)

(73) Assignee: ECOLE POLYTECHNIQUE FEDERALE DE LAUSANNE (EPFL), Lausanne (CH)

(21) Appl. No.: 18/275,191

(22) PCT Filed: Jan. 30, 2021
(86) PCT No.: PCT/IB2021/050753

§ 371 Date: Jul. 31, 2023

(51) Int. Cl. G06V 10/774; G06V 10/762; G06V 10/77; G06V 10/776; G06V 10/82

(52) U.S. Cl. CPC G06V 10/7753; G06V 10/762; G06V 10/7715; G06V 10/776; G06V 10/82

(57) ABSTRACT

The present invention proposes a method for detecting anomalous or out-of-distribution images in a machine learning system (1) comprising a pre-training network with a first encoder, and an anomaly detection network with a second encoder. The system is first pre-trained by training the pre-training network, and then subsequently fine-tuned by training the anomaly detection network. According to one example, during pre-training, only unlabelled training images are used, while during fine-tuning, a small fraction of labelled training images is used in addition to unlabelled training images. The method can be applied to both single and multi-domain image data.

### TECHNICAL FIELD

The present invention relates to an image recognition method, which is particularly advantageous in the context where only very few labelled training images are available. More specifically, but not by way of limitation, the proposed method provides efficient image anomaly detection, and it allows tedious image annotations to be bypassed. The present invention also relates to a corresponding imaging apparatus configured to carry out the proposed method.

### BACKGROUND OF THE INVENTION

Currently, supervised-based deep learning approaches are ubiquitous and they achieve state-of-the-art performance for various tasks, including anomaly detection in image data. However, obtaining labels for image data is expensive. For example, every day, large amounts of healthcare data, e.g. medical images, have become available in various healthcare organisations, such as large hospitals that constitute precious and unexploited resources. Nevertheless, their annotation is missing, and medical images or images in other application fields require precise and time-consuming analysis from domain experts, such as radiologists. This hinders the applicability of supervised-based machine learning models in a real scenario that require large amounts of annotated training data.

This issue is further exacerbated for large-scale data sets as they usually suffer from the problem of data imbalance. Training a machine learning system on an imbalanced dataset can introduce unique challenges to the learning problem. Imbalanced data normally refers to a classification problem where the number of observations per image class is not equally distributed. More specifically, often a large amount of data/observations exist for one class (referred to as a majority class), and much fewer observations for one or more other classes (referred to as the minority classes). For real large-scale data, the amount of data of different categories will often not be an ideal uniform distribution, and these data sets usually exhibit long-tailed label distributions if the classes are sorted along the x-axis according to the number of samples from high to low, and where the y-axis represents the number of occurrences per class. In the case of anomaly detection, anomalies are usually rare in the collected data, and deep neural networks have been found to perform poorly on rare classes of anomalies. This particularly has a pernicious effect on the deployed model if more emphasis is placed on minority classes at inference time. Therefore, training models in a fully unsupervised or self-supervised fashion would be advantageous, allowing a significant reduction of time spent on the annotation task.

Another critical issue of most existing anomaly detection methods is that they can only be applied to data from a single image domain. The pre-trained deep anomaly detection networks suffer significant performance degradation when exposed to a new image dataset from an unfamiliar distribution. Using available ad hoc domain adaptation techniques only provides suboptimal solutions. These techniques also need label-rich source domain data to transfer knowledge from source domain data to unseen target domain data.

### SUMMARY OF THE INVENTION

It is an object of the present invention to overcome at least some of the problems identified above related to image processing methods and their related systems. More specifically, one of the objects of the present invention is to propose a solution for detecting anomalous or out-of-distribution images.

According to the first aspect of the invention, there is provided a method in a machine learning system for detecting anomalous images as recited in claim 1.

The proposed image detection method has the advantage that it builds upon self-supervised learning such that the system can be trained with only a small amount of annotated data, and it avoids potential bias thereby making it practical in real-world scenarios. The present invention has also the advantage that it allows tedious annotations to be bypassed, or at least the number of image annotations can be significantly reduced. Maybe even more importantly, the proposed method is capable of working with both single and multi-domain image data. In other words, the proposed method can be understood as a new cross-modality image anomaly detection method. Thus, this means that the proposed method is particularly advantageous for improving anomaly detection in the presence of domain shift, and the module or system implementing the proposed method can be easily plugged into existing image recognition systems to improve their generalisation ability. Furthermore, the proposed method also solves the class imbalance problem.

According to a second aspect of the invention, there is provided a non-transitory computer program product comprising instructions for implementing the steps of the method according to the first aspect of the present invention when loaded and run on computing means of a computation apparatus.

According to a third aspect of the invention, there is provided a machine learning system configured to carry out the method according to the first aspect of the present invention.

Other aspects of the invention are recited in the dependent claims attached hereto.

### BRIEF DESCRIPTION OF THE DRAWINGS

Other features and advantages of the invention will become apparent from the following description of a non-limiting example embodiment, with reference to the appended drawings, in which:

FIG. 1 is a schematic illustration of a machine learning system where the teachings of the present invention can be implemented; and

FIGS. 2a and 2b show a flow chart illustrating an image processing method for detecting anomalous or out-of-distribution images according to an example embodiment of the present invention.

### DETAILED DESCRIPTION OF AN EMBODIMENT OF THE INVENTION

An embodiment of the present invention will now be described in detail with reference to the attached figures. The embodiment is described in the context of a deep artificial neural network which is configured to detect anomalous or out-of-distribution images, but the teachings of the invention are not limited to this environment. For instance, the teachings of the present invention could be used in other types of artificial intelligence or machine learning systems. The teachings of the present invention may be applied in various technical fields including for instance medical applications (medical images), defect detection in industrial production (e.g. in watch industry), waste detection and analysis, remote sensing (aerial) imaging, event detection in sensor networks, etc. Identical or corresponding functional and structural elements which appear in the different drawings are assigned the same reference numerals. It is to be noted that the use of words “first”, “second” and “third”, etc. may not imply any kind of particular order or hierarchy unless this is explicitly or implicitly made clear in the context.

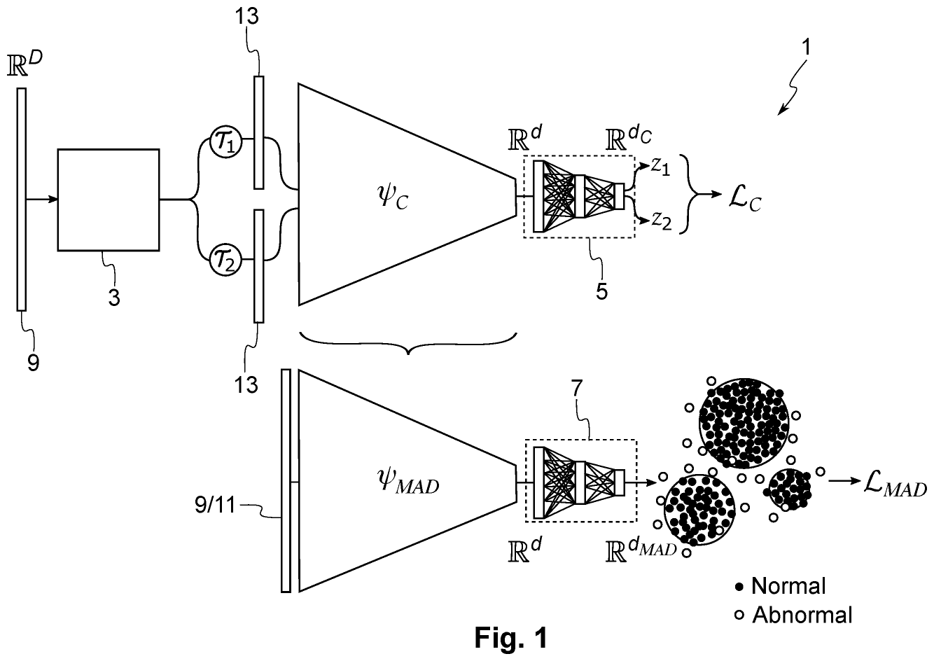

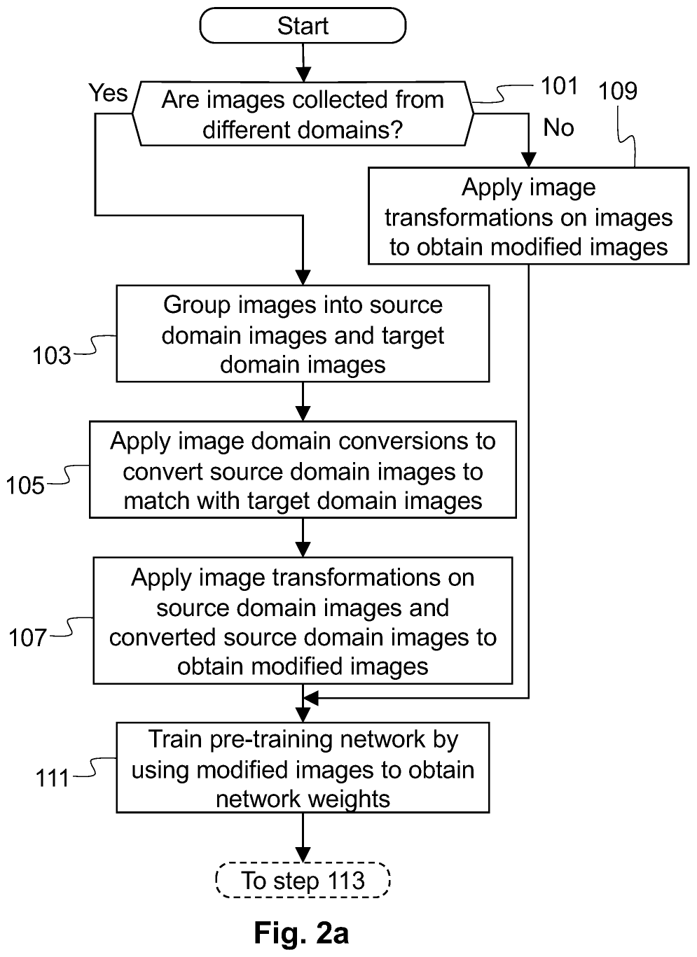

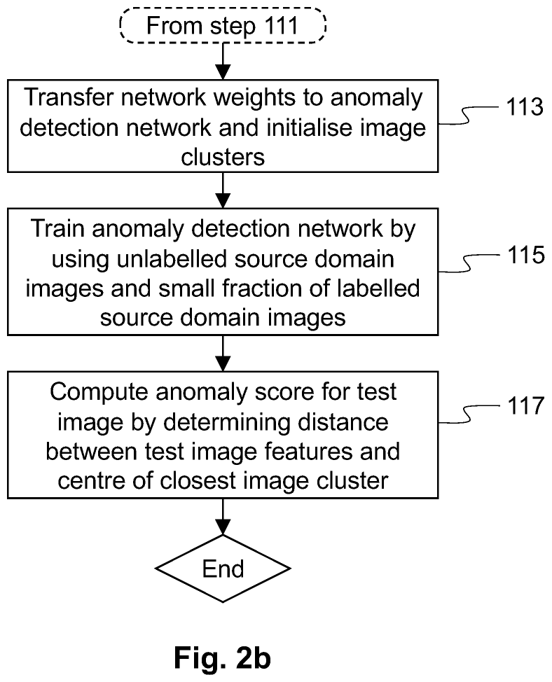

FIG. 1 schematically illustrates a machine learning or artificial intelligence system 1, which is configured to carry out the proposed method as explained later in more detail. In this example, the machine learning system 1 is an artificial neural network. The actual machine learning part of the system can be understood to comprise two main parts, namely a first or pre-training network and a second, fine-tuning or anomaly detection network. An image processing unit 3 is also provided to carry out image transformations for instance. The transformed images can then be fed into the pre-training network. The pre-training network comprises a first or pre-training encoder ψ_{C}, and a first projection head network 5. The anomaly detection network on the other hand comprises a second or fine-tuning encoder ψ_{MAD}, and a second projection head network 7. In this example, both the encoders and both the projection heads are artificial neural networks with a given number of layers and a given number of connections characterised with their weights linking two adjacent layers to each other. More specifically, the first and second encoders are in this example convolutional encoders. The first and second encoders ψ_{C}, ψ_{MAD}, as well as the first and second projection head networks 5, 7 are configured to process an incoming image and at the same time compress it so that an output data element of the respective projection head is a lower dimensional set of features compared with a feature dimension of an input image at an input of the respective encoder. However, it is to be noted that the pre-training network and the anomaly detection network could instead of being physically separate networks be one physical network, i.e. a deep neural network, and more specifically a convolutional neural network. The operation of the system 1 is next explained in more detail with reference to the flow charts of FIGS. 2a and 2b.

The process starts in step 101, where it is determined whether or not the incoming image data stream contains a single imaging modality. In the present description, an imaging or image modality is understood to mean an imaging or image domain or image type more broadly. For example, different image modalities can be distinguished by any property of the target object(s) (such as the object category, colour, etc.) in the respective image, the imaging protocols, scanners, or software used to capture or process the images, etc. If at least two image modalities are detected, in other words, it is detected that incoming training images 9 are collected from at least two different domains (i.e. the case of multimodal data), then in step 103, the training images 9 are grouped based on their image modalities into source domain images and target domain images. Here, the source domain refers to the domain of image data where the majority of the images are unlabelled, and a small fraction of the images are labelled, and the aim is to transfer anomaly detection from the source domain to a new image data set (target or test domain) from an unfamiliar distribution, where the target domain images are not labelled. In other words, a small portion of the source domain images are labelled (e.g. 1% to 10% of the images in that domain), while the target domain images are unlabelled according to the present example. Test images are all from the target domain.

In step 105, a deep generative model is trained, and the source domain images or at least some of them are transformed by this model to transform them into the appearances of the target domain. During this transformation, the source domain image's content, such as the shape, objects' category, and object structure, is preserved while other image properties such as the style information optionally including texture and/or the colour are converted or translated from a target domain image to an image in the source domain. More specifically, an image domain conversion or mapping is applied to convert the source domain images to match with the target domain images in terms of style information such as texture and/or the colour. In this manner, image transformations or converted or transformed source domain images are obtained. The cross-modality image conversion model or mapping function to implement this step, and which in the system shown in FIG. 1 is implemented by the image processing unit 3, can be chosen using for example state-of-the-art image synthesis approaches, such as the one according to Cheng Chen, Qi Dou, Hao Chen, Jing Qin, and Pheng Ann Heng, “Unsupervised bidirectional cross-modality adaptation via deeply synergistic image and feature alignment for medical image segmentation”, IEEE Transactions on Medical Imaging, 2020.

The proposed method uses a two-step training process to learn image representations, also referred to as image features, of unlabelled data using a pre-training process, in the present description also referred to as a pretext task, at a pre-training stage, and then adapt those representations to the actual task of semi-supervised anomaly detection. The pre-training stage aims to leverage unlabelled data in a task-agnostic way using a defined pretext objective. Let ϕ_{C}(·, W_{C}) : [symbol] ^{D}→ [symbol] ^{d}^{_{c}} be an image encoder (i.e. the pre-training network) with L_{C} hidden layers and weights W_{C}={_{C}¹, . . . , W_{C}^{L}^{_{C}}}. ϕ_{C} consists of the first image encoder ψ_{C} that maps an input or incoming image 9 in [symbol] ^{D} (also referred to as an input feature space or pre-training network input feature space) to a compressed representation in [symbol] ^{d} (also referred to as a first feature space) followed by the first projection head network 5 that further compresses the input into [symbol] ^{d}^{_{c}} (also referred to as a second feature space or pre-training network output feature space). A feature space may be understood as a D-dimensional variable space where the respective variables are located. Often a task in machine learning involves feature extraction. Hence, all variables can be understood as features. Let us define a transformation T : [symbol] ^{D}→ [symbol] ^{D} that heavily modifies the respective input images 9, i.e. the operation augments the number of the images that can be used in the training process, as the transformation generates new images. Thus, referring back to the flow chart, in step 107, in multimodal data, transformations, which in this example are stochastic transformations are applied to both the source domain images and the converted source domain images obtained in step 105 to obtain transformed or modified images 13. In this example, the images are randomly modified but this does not have to be the case. The transformation operations may include one or more of the following operations: applying random colour Jittering to the respective images, cropping randomly resized patches from the respective images, and applying Gaussian Blur to the respective images.

On the other hand, if in step 101 it was determined that the incoming images 9 in the incoming data stream are all from a single modality, then the process continues in step 109, where the above-explained image transformations are applied to the source domain images (which are thus all from the same modality) to obtain transformed or modified images 13.

Next, in step 111, training of the pre-training network is carried out as explained next in more detail. The goal of the pre-training (i.e. the pretext task) is to optimise the weights W_{C} of the pre-training network ϕ_{C} such that two versions of an image modified by T are brought together in representation space [symbol] ^{d}^{_{C}}, which is the feature space at the output of the first projection head network 5. Besides, by pushing the representations of any two of the modified images 13, which may be modified source domain images or modified converted source domain images (in the case of multimodal data), to be close to each other in the feature space, the network is leaned to be invariant to the data domain. In other words, during the iterative pre-training phase, two heavily transformed versions of an image are enforced to or towards the same point in the feature space. The pre-training network should thus learn meaningful features independent of the applied transformation. In practice, for an image pair {xᵢ, xⱼ} (which are thus both modified images 13 and forms a training image set of modified images or a modified image set) in the set of positive pairs [symbol] , the network is trained to identify xⱼ from a set of N images {xₖ}_{k≠i}. In this example, this is done by maximising a similarity method, which in this example is the cosine similarity between the representation of a pair (ϕ_{C}(xᵢ)=zᵢ and (xⱼ)=zⱼ) and minimising the cosine similarity with respect to the other samples' representations of the set of N images. The pretext task's objective L_{C} can thus be formulated as

$${min}_{{w}_{c}} {\sum }_{( i , j ) ∈ 𝒫} - log \frac{exp ( sim ( {z}_{i} , {z}_{j} ) / τ )}{{\sum }_{k = 1}^{2 N} {1}_{[ k \neq i ]} exp ( sim ( {z}_{i} , {z}_{k} ) / τ )} , \qquad ( 1 )$$

where zᵢ=ϕ_{C}(xᵢ; W_{C}) and

$$s i m ( u , v ) = \frac{{u}^{T} v}{‖ u ‖ ‖ v ‖}$$

and 1_{k≠i} ∈ {0,1} is a function giving 1 if k≠i. N denotes the number of samples within a set of images or image set, i.e. in a minibatch, and τ is a first hyperparameter called temperature. This loss is also known as the InfoNCE loss as taught by Aaron van den Oord, Yazhe Li, and Oriol Vinyals, “Representation Learning with Contrastive Predictive Coding”, arXiv:1807.03748 [cs, stat], January 2019. arXiv: 1807.03748. 9. It is to be noted that each minibatch is in this example a user-specified number of training images. So instead of using all training images to compute gradients (as in stochastic training), minibatch training uses a user-specified number of training images at each iteration of the optimisation.

The optimisation process implemented during the pre-training phase may use an algorithm called stochastic gradient descent (SGD). The algorithm's aim is to find a set of internal model parameters that perform well against some performance metrics, such as the above-defined loss term of Equation 1. The algorithm's iterative nature means that the search process occurs over multiple discrete steps; each step ideally slightly improves the model parameters. Each step involves using the model with the current set of internal parameters to make predictions on a randomly sampled minibatch (few images) without replacement, comparing the predictions to the expected outcomes, calculating the error, and using the error to update the internal model parameters.

The first encoder ψ_{C} is configured to process a plurality of image pairs at the same time from each minibatch. The objective is to learn a unique representation of each image so that the modified images from a given image pair (positive pair) should be similar to each other while at the same time be different from other images and their modified versions (negative pairs). To be more specific, the pre-training network randomly samples a minibatch of N images and defines the InfoNCE loss on pairs of modified images derived from the minibatch, resulting in 2N data points. Given a positive pair of modified images from the same image, the other 2(N−1) modified images within a minibatch are considered as negative pairs. The final loss is computed across all positive pairs, both (i, j) and (j, i) in a minibatch, e.g., (x₁, x₄) and (x₄, x₁). The pre-training network thus advantageously forms all possible image pair combinations from the modified source domain images and optionally from the modified converted source domain images (in the case of multimodal data).

After the pre-training phase, the weights of the first encoder ψ_{C} are used to initialise the second encoder ψ_{MAD} for anomaly detection in step 113. In this example, hypersphere centres N_{S} (in this example their locations are determined) are initialised using the K-means algorithm on the embedded normal samples, i.e. the features of the normal images, as opposed to anomalous image samples, and then non-meaningful clusters are removed progressively during the optimisation procedure in step 115. Hyperspheres are understood to define image clusters as becomes clear later. The K-means algorithm is a clustering algorithm, which is a method of vector quantisation that aims to partition a given number of observations into K clusters in which each observation belongs to the cluster with the nearest mean (cluster centres), serving as a prototype of the cluster. This results in a division of the data space into Voronoi cells. Hyperspheres are understood to be multidimensional spheres in the multidimensional representation or feature space. Furthermore, non-meaningful clusters refer to those image clusters in which the cluster cardinality is not large enough or include noisy samples. The system 1 does not have prior knowledge about the number of clusters at the beginning, and the number of clusters (hyperspheres) is set to be quite large at the beginning for initialisation. Then, the non-meaningful clusters (those clusters in which the cluster cardinality is not large enough or they include noisy samples) are removed progressively during the optimisation procedure in step 115. For example, the process may start with 10 clusters (hyperspheres) and end up with five clusters at the end of optimisation. In other words, the system 1 automatically obtains the optimal number of image clusters after optimisation.

In step 115, training of the anomaly detection network, i.e. fine-tuning of the machine learning system 1, is carried out. Formally we have access to n unlabelled samples x₁, . . . , xₙ ∈ X with X⊆ [symbol] ^{D}, where D is the input dimension. In addition to the unlabelled samples, we have access to few m labelled samples (\tilde{x}₁, \tilde{y}₁), . . . , (\tilde{x}ₘ, \tilde{y}ₘ) ∈ X×y, where y={−1, +1}. Known normal samples are labelled as \tilde{y}=+1 and known abnormal samples are labelled as \tilde{y}=−1. Let ϕ_{MAD} (·, W_{MAD}) : [symbol] ^{D}→ [symbol] ^{d}^{_{MAD}} be the anomaly detection network with L_{MAD} hidden layers and weights W_{MAD}={W_{MAD}¹, . . . , W_{MAD}^{L}^{_{MAD}}}. The goal of the iterative downstream task, i.e. the fine-tuning step, is to train the anomaly detection network ϕ_{MAD} to transform the input into a lower dimension d_{MAD} in [symbol] ^{d}^{_{MAD}} (which is also referred to as a third feature space or anomaly detection network output feature space) such that the normal samples are enclosed in N_{S} hyperspheres of minimum volume centred on N_{S} defined points in [symbol] ^{d}^{_{MAD}}: c={c₁, . . . , c_{N}_{ₛ}}, and abnormal samples are mapped away from all hyperspheres' centres. In this example, the dimensions of the feature spaces [symbol] ^{d}^{_{C}} and [symbol] ^{d}^{_{MAD}} are the same. The objective L_{MAD} can be thus written as:

$${min}_{{w}_{MAD}} \frac{1}{n + m} {\sum }_{i = 1}^{n} {‖ {ϕ}_{MAD} ( {x}_{i} ; {𝒲}_{MAD} - {c}_{k} ) ‖}^{2} + \frac{η}{n + m} {\sum }_{j = 1}^{m} {( {‖ {ϕ}_{MAD} ( {\tilde{x}}_{i} ; {𝒲}_{MAD} - {c}_{k} ) ‖}^{2} )}^{{\tilde{y}}_{j}} + \frac{λ}{2} {\sum }_{l = 1}^{L} {‖ {W}_{MAD}^{l} ‖}^{2} , \qquad ( 2 )$$

where the centre k is assigned as the closest hypersphere centre to the image under assessment, i.e. k=ⱼ ∥ϕ_{MAD} (xᵢ; W_{MAD}−cⱼ)∥. The first term in Equation 2 penalises unlabelled points away from the closest centre since we assume that a majority of unlabelled samples come from the normal distribution. The second term in Equation 2 pushes known abnormal samples away from the closest centre and known normal samples towards that centre. Finally, the third term in Equation 2 imposes a regularisation on the network's weights W_{MAD} with a second hyperparameter λ. A third hyperparameter η controls the relevance of the labelled terms in Equation 2. We opt for two-phase training instead of a joint training setting due to the difference in the data processed by each phase, and the two-phase training also requires fewer hyperparameters (scales of loss, etc.). The images used in step 115 are the training images 9, and more specifically the source domain images and optionally also the converted source domain images in the case of the multimodal data. In this step, the training images 9, which may be the same as the ones used in step 111, or they may be different or at least partially different training images.

The second encoder's ψ_{MAD} weights W_{MAD} are in this example updated for the anomaly detection task (Equation 2) by using stochastic gradient descent (SGD) using backpropagation until convergence. At each step, a cluster centre is kept only if the cardinality of normal samples is greater than a fraction γ of the maximum cardinality. It ensures that the model learns the best number of centres without any a priori on the number of modes. Upon testing, in step 117, an anomaly score of a sample, i.e. a test image 11, is given by for example computing the distance or other distance metric between its embedding or features and the closest hypersphere centre: S_{MAD}(x)=∥ϕ_{MAD}(x; W_{MAD}−cₖ)∥ where k=ⱼ ∥ϕ_{MAD}(xᵢ; W_{MAD}−cⱼ)∥ is the closest hypersphere centre. However, other ways to compute the anomaly score exist. The distance metric may be based on the Euclidean distance between the features of the test image and the features of the closest hypersphere centre which have the same dimension as the dimension of the features of the test image. However, the distance metric can be defined more broadly. For example, one can consider the most similar clusters (hyperspheres) with respect to the test image, e.g. by using the top-k matches.

The above-described example method uses a pairwise setup to compute the distance metric, but this formulation can be extended to consider triplets of training data samples or even higher number of training data samples. More specifically, for example, instead of generating two modified images 13 from any given training image 9, three modified images may be generated (in the case of triplets), and then fed into the first encoder ψ_{C}. The above teachings may be applied to these three images to enforce their feature representations to or towards the same point in the feature space at the output of the pre-training network with a feature dimension [symbol] ^{d}^{_{C}}. The same holds true for quadruplets, etc. when applied to the first encoder ψ_{C}.

The above-described method may be carried out by suitable circuits or circuitry. The terms “circuits” and “circuitry” refer to physical electronic components or modules (e.g. hardware), and any software and/or firmware (“code”) that may configure the hardware, be executed by the hardware, and/or be otherwise associated with the hardware. The circuits may thus be configured or be operable to carry out or they comprise means for carrying out the required method as described above.

While the invention has been illustrated and described in detail in the drawings and foregoing description, such illustration and description are to be considered illustrative or exemplary and not restrictive, the invention being not limited to the disclosed embodiments. Other embodiments and variants are understood, and can be achieved by those skilled in the art when carrying out the claimed invention, based on a study of the drawings, the disclosure and the appended claims. Further variants may be obtained by combining the teachings of any of the designs explained above.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used. Any reference signs in the claims should not be construed as limiting the scope of the invention.

1. A computer-implemented method for detecting anomalous or out-of-distribution images in a machine learning system comprising a pre-training network comprising a first encoder, and an anomaly detection network comprising a second encoder, the method comprising:
applying image transformations on training images to obtain modified images;
training the pre-training network by feeding at least some of the modified images in a training image set to the pre-training network such that a similarity metric of representations of respective modified images in a respective training image set is increased when measured in a pre-training network output feature space at an output of the pre-training network with respect to the similarity metric when measured in a pre-training network input feature space to thereby obtain first encoder weight parameters;
transferring the first encoder weight parameters to the anomaly detection network to initialise the second encoder with the first encoder weight parameters;
initialising image clusters, which are centred at a respective cluster centre in an anomaly detection network feature space at an output of the anomaly detection network;
training the anomaly detection network by using at least labelled training images and unlabelled training images such that the anomaly detection network is trained to map images detected as normal inside a respective image cluster, while moving images detected as anomalous away from the image clusters; and
determining an anomaly score for a test image by determining a distance metric of its representation in the anomaly detection network output feature space with respect to at least the cluster centre closest to the test image.

2. The method according to claim 1, wherein the pre-training network input feature space is characterised by a first feature dimension, and the pre-training network output feature space is characterised by a second, smaller feature dimension.

3. The method according to claim 1, wherein the pre-training network is trained such that the similarity metric of the representations of the respective modified images in the respective training image set of modified images is maximised in the pre-training network output feature space.

4. The method according to claim 1, wherein the pre-training network is trained such that the similarity metric of the representations of the respective modified images in the respective training image set of modified images is decreased in the pre-training network output feature space with respect to other image representations in the pre-training network output feature space in a given image set.

5. The method according to claim 1, wherein the similarity metric is a cosine similarity between the representations of the respective modified images in the respective training image set of modified images, and wherein the cosine similarity of the representations of the respective modified images in the respective training image set of modified images is minimised with respect to other image representations in a given image set.

6. The method according to claim 1, wherein the pre-training network is trained to urge the representations of the respective modified images in the respective training image set of modified images to become closer in the pre-training network output feature space.

7. The method according to claim 1, wherein training the anomaly detection network comprises minimising the following objective L_{MAD}:
$$\frac{1}{n + m} {\sum }_{i = 1}^{n} {‖ {ϕ}_{MAD} ( {x}_{i} ; {𝒲}_{MAD} - {c}_{k} ) ‖}^{2} + \frac{η}{n + m} {\sum }_{j = 1}^{m} {( {‖ {ϕ}_{MAD} ( {\tilde{x}}_{i} ; {𝒲}_{MAD} - {c}_{k} ) ‖}^{2} )}^{{\tilde{y}}_{j}} + \frac{λ}{2} {\sum }_{l = 1}^{L} {‖ {W}_{MAD}^{l} ‖}^{2} ,$$
where ϕ_{MAD} denotes the anomaly detection network, n denotes the number of unlabelled training images, W_{MAD} denotes weights of the anomaly detection network, xᵢ denotes a training image, k=ⱼ ∥ϕ_{MAD}(xᵢ; W_{MAD}−cⱼ)∥, cⱼ denotes the centre point of a hypersphere j in the anomaly detection network output feature space, λ denotes a second hyperparameter, and η denotes a third hyperparameter.

8. The method according to claim 1, wherein the method further comprises determining whether or not the training images comprise images from more than one image domain.

9. The method according to claim 1, wherein the method further comprises grouping the training images into source domain images and target domain images.

10. The method according to claim 9, wherein the method further comprises applying image domain conversions on the source domain images to convert the source domain images to match with the target domain images to obtain converted source domain images, and applying the image transformations on the source domain images and the converted source domain images to obtain the modified images.

11. The method according to claim 1, wherein the image transformations are random image transformations.

12. The method according to claim 1, wherein the first and/or second encoders are artificial convolutional neural networks.

13. The method according to claim 1, wherein the initialisation comprises determining locations of the cluster centres in the anomaly detection network output feature space for training images classified as normal.

14. The method according to claim 1, wherein the image clusters are initialised by using a K-means algorithm on features training images classified as normal.

15. The method according to claim 1, wherein the pre-training network is trained by feeding at least some of the modified images pairwise to the pre-training network, and wherein the training image set forms a pair of modified images.

16. The method according to claim 1, wherein at most 5% of the training images are labelled.

17. The method according to claim 16, wherein the labelled images are labelled either as normal or abnormal.

18. The method according to claim 1, wherein the number of the labelled training images used to train the anomaly detection network is at most 5% of the number of all the training images used to train the anomaly detection network.

19. The method according to claim 1, wherein the pre-training network is trained only with unlabelled training images.

20. A non-transitory computer program product comprising instructions for implementing the steps of the method according to claim 1 when loaded and run on computing means of a computing device.

21. A machine learning system for detecting anomalous or out-of-distribution images, the machine learning system comprising a pre-training network comprising a first encoder, and an anomaly detection network comprising a second encoder, the machine learning system being configured to perform operations comprising:
apply image transformations on training images to obtain modified images;
train the pre-training network by feeding at least some of the modified images in a training image set to the pre-training network such that a similarity metric of representations of respective modified images in a respective training image set is increased when measured in a pre-training network output feature space at an output of the pre-training network with respect to the similarity metric when measured in a pre-training network input feature space at an input of the pre-training network to thereby obtain first encoder weight parameters;
transfer the first encoder weight parameters to the anomaly detection network to initialise the second encoder with the first encoder weight parameters;
initialise image clusters, which are centred at a respective cluster centre in an anomaly detection network output feature space at an output of the anomaly detection network;
train the anomaly detection network by using at least labelled training images and unlabelled training images such that the anomaly detection network is trained to map images detected as normal inside a respective image cluster, while moving images detected as anomalous away from the image clusters; and
determine an anomaly score for a test image by determining a distance metric of its representation in the anomaly detection network output feature space at the output of the anomaly detection network with respect to at least the cluster centre closest to the test image.
